(19) United States
(12) Patent Application Publication
(10) Pub. No.: US 2025/0191384 A1
(43) Pub. Date: Jun. 12, 2025

(54) System and Method for Automated Driver-Impairment Detection and Safety-Protocol Activation

(71) Applicant: Vincent Loccisano, Wellesley, MA (US)

(72) Inventor: Vincent Loccisano, Wellesley, MA (US)

(21) Appl. No.: 19/049,842

(22) Filed: Feb. 10, 2025

(51) Int. Cl. G06V 20/59; B60K 28/06; B60W 40/08; G06V 20/56; G06V 40/18; G06V 40/20

(52) U.S. Cl. CPC G06V 20/597; B60K 28/06; B60W 40/08; G06V 20/56; G06V 40/18; G06V 40/25; B60W 2040/0836

(57) ABSTRACT

A system and method for detecting driver impairment uses a combination of on-board sensors and cameras together with sensors and cameras from devices such as cell phones and smart watches. A central-processing unit storing an application receives data from the sensors, cameras and personal electronic devices. The application processes this data to detect signs of impairment and to initiate appropriate safety actions.

### TECHNICAL FIELD

The present disclosure relates generally to vehicle safety systems and specifically to systems and methods for detecting driver impairment using on-board sensors including forward-facing cameras, eye-tracking sensors and eye-detection cameras, side-view cameras and rear-view cameras.

### BACKGROUND OF THE INVENTION

Driver impairment, whether due to alcohol, drugs or exhaustion, is a significant factor contributing to road accidents. Focusing only on reactive measures, or relying on manual checks by law enforcement, existing technologies fall short of technological ability.

Modern vehicles' forward-facing cameras and driver eye-tracking sensors are increasingly integrated into advanced driver-assistance systems (ADAS) to enhance safety and to monitor driver capabilities. Forward-facing cameras capture images of the road ahead of the vehicle, providing critical data for features such as lane-departure warning systems, automatic emergency braking and adaptive cruise control.

Driver eye-tracking sensors and cameras often use infrared technologies to monitor the driver's gaze direction and eye movements to detect drowsiness, distraction and inattention.

Rearview cameras, usually mounted on or near the rear license plate of a vehicle, provide a view of the area behind the vehicle.

Side-view cameras, located on or under the side mirrors of a vehicle, capture a view of most of the length of a vehicle's side. These cameras are designed to monitor blind spots and may be combined with forward-facing and rearview cameras to support surround-view systems. Surround-view systems combine images from multiple cameras to create a 360° top view of the vehicle and its surroundings. Side-view sensors measure the existence of objects rather than an image of them. Sensors are more accurate in detecting objects and function better than cameras in low light and foggy environments.

Most automotive cameras use Complimentary Metal-Oxide-Semiconductor (CMOS) image sensors, which are compact and energy-efficient. Some cameras and sensors use infrared technology to improve visibility in low-light conditions. Image-processing software may be used together with CMOS cameras to interpret images and extract relevant information, detecting objects, recognizing lanes and identifying traffic signs.

Bluetooth Low Energy (BLE) is a low-power wireless communication technology that uses transmitters and receivers to enable devices to communicate over short distances. Smart phones may be used as BLE transmitters. Near-field communication (NFC) is a short-range wireless communication technology that functions in devices in very close proximity, usually a few centimeters, to establish connection. Car-key fobs, also known as remote keyless entry (RKE), use radio-frequency (RF) signals to communicate, sending a signal to a vehicle's receiver to activate a vehicle start button.

Some vehicles integrate data from cameras and sensors with Advanced Driver Assistance Systems (ADAS) to enhance safety systems. For example, sudden braking or swerving detected by these camera sensors may be combined with data from accelerometers to provide a comprehensive picture of an accident.

Transdermal alcohol sensors, sometimes worn as as a wristband or patch, offer a non-invasive method for continuous alcohol monitoring by measuring the alcohol excreted through one's skin.

Automobile electronics, including computers, electrical cables, and software protocols, are together known as a controller-area network (CAN), or CANbus. A CAN is a vehicle's main computer system. Through the CANbus, data travels through the system to the many subsystems such as those controlling the engine, the transmission, doors, windows, and other subsystems. Each of these subsystems is controlled by an electronic control unit (ECU). Current vehicles may have fifty or more ECUs, each able to sense signals indicating, for example: acceleration at various angles; voltage; pressure; braking; vehicle roll and yaw; steering angle; temperature, and other variables. The CANbus routes signals from sensors to computers as communicated by each ECU. An ECU can monitor voltage used by a subsystem and communicate that information through the CANbus to actuate, for instance, stopping a power-sliding door from closing on a passenger's limb, or adjusting a fuel injector's performance.

Adding to or changing a vehicle's electronic features once required extensive wiring. With the development of CAN in the last forty years, feature development (such as adding passenger-controlled climate options) has become physically easier because each new feature can now be added by programming new computer code into the CAN. Now, all vehicle features as well as vehicle diagnostics are controlled via CAN, which uses a standardized protocol called OBD-II. New features can be integrated into a vehicle by developing and uploading an algorithm into the vehicle's CAN.

Current technologies may not adequately address the risks associated with driver impairment because they do not take a proactive, automated approach to detect driver impairment, which would enable more responsive safety actions.

### SUMMARY OF THE INVENTION

A system and method for detecting driver impairment uses a combination of on-board sensors and cameras together with sensors and cameras from personal electronic devices such as cell phones and smart watches. A central-processing unit storing an application receives data from the sensors, cameras and personal electronic devices. The application processes this data to detect signs of impairment and to initiate appropriate safety protocols.

The system identifies a driver by the driver's cell phone, FOB or keycard, any of which has been previously linked to the vehicle for purposes of identifying the driver and unlocking the vehicle.

In one embodiment, the system has a central-processing unit storing an application that interfaces with a vehicle CANbus to engage exterior cameras such as forward-facing, rearview, and side cameras, as well as sensors. Once a vehicle owner has been identified by their linked cell phone, FOB or keycard, the system collects data from the cameras and sensors. The system application analyzes the data to monitor the driver's gait and movement as they approach the vehicle to identify potential signs of impairment. If impairment is detected at this stage, a safety protocol is initiated.

As the driver enters the vehicle and begins to drive, the system employs on-board eye detection sensors and a driver-facing camera to gather and analyze data to detect impairment. Transdermal alcohol sensors located on the surface of the steering wheel detect alcohol levels in a driver's perspiration. Additional sensors, such as accelerometers and gyroscopes in the vehicle detect erratic or abnormal driver behavior. Sensors such as accelerometers and gyroscopes in a driver's cell phone or smart watch, detect erratic driver movement or behavior.

When impairment is detected, the system may enact a safety protocol that may curtail or stop the operation of a vehicle. For example, sensors detecting gait, movement and gestures signifying impairment as a driver approaches or enters a parked vehicle can activate a mechanism that prevents the vehicle from starting. If impairment is detected while the vehicle is moving, various curtailment actions may be initiated; these might be an audible warning; warnings sent wirelessly to another party; speed-curtailment, or other preventive actions. In situations in which a driver is under court order or parental control, the application may engage a continuous-monitoring mode to prevent the vehicle from starting until sensors and cameras have communicated to the system's software application that no impairment is detected.

A safety protocol may entail stopping the vehicle from being driven, or may require that the driver perform an action to prove a lack of impairment. In one embodiment alcohol sensors embedded in the steering wheel may detect that there is no impairment. This can be important when the vehicle is rented, and is particularly important when the vehicle is rented on a short term basis. One skilled in the art is familiar with active sobriety tests and the like.

One skilled in the art understands that impairment may be due to drugs, alcohol, or exhaustion. A personal electronic device may be a smartphone, smartwatch, FOB other electronic device intended for individual use.

### BRIEF DESCRIPTION OF DRAWINGS

FIG. 1 is a diagram illustrating the system of the embodiment.

FIG. 2 is a diagram illustrating a method of using the system of claim 1.

### DETAILED DESCRIPTION

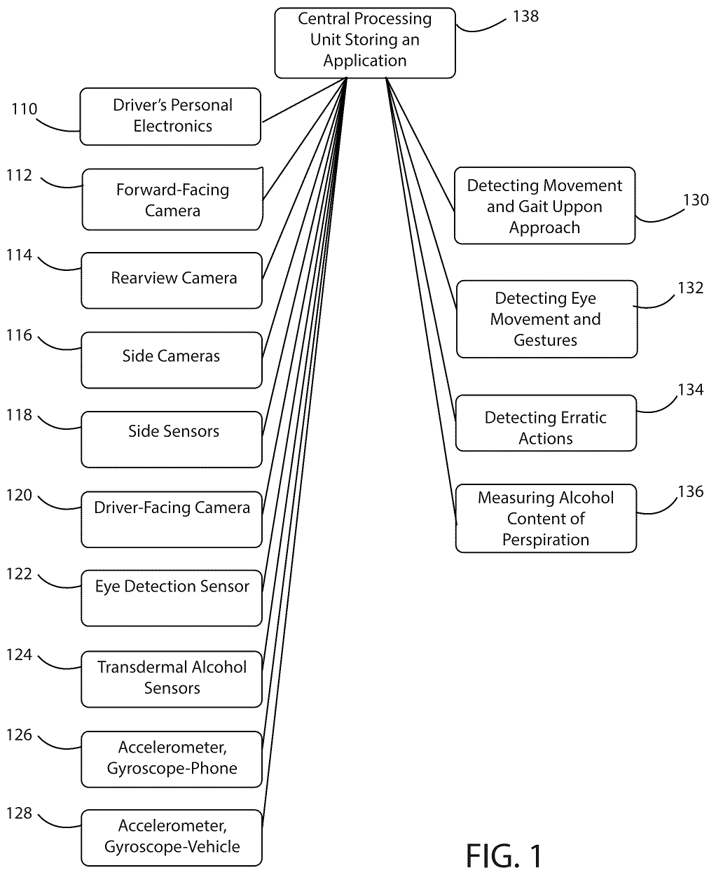

FIG. 1 is a diagram of an example system of the disclosure 100. A central-processing unit 138 stores an application. The application receives data from a driver's personal electronics 110 (such as a cell phone, key fob, or smartwatch), then gathers data from a vehicle's forward-facing camera 112, rearview camera 114, side cameras 116, side sensors 118, driver-facing camera 120, eye-detection sensor 122, transdermal alcohol sensors 124, accelerometer and gyroscope in a driver's phone 126, and accelerometer and gyroscope in the vehicle 128. Initial data is received from the driver's personal electronics 110 as the driver approaches the vehicle. The data is processed in the application in the central-processing unit 138 to identify the driver. Once identified, the application monitors data from the vehicle's external cameras, including the forward-facing camera 112, rearview camera 114, side cameras 116, and side sensors 118, to assess the driver's movement and gait as they approach the vehicle 130 to detect impairment. Upon entering the vehicle, the application in the central-processing unit 138 gathers data from the vehicle's driver-facing camera and eye-detection sensor to detect eye movement and gestures 132 that may indicate impairment. In some embodiments, the application gathers data from transdermal alcohol sensors in the steering wheel 124 to detect an undesirable alcohol level in the driver's perspiration 136.

Once the vehicle is in motion, the application gathers data from an accelerometer and gyroscope in the driver's smartphone or smartwatch 126 and processes the data to measure body movements to detect erratic actions that may signify impairment 134. The application also gathers data from an accelerometer and gyroscope in the vehicle 128 to detect erratic driving actions 134 while the vehicle is in motion. The application continues monitoring the forward-facing camera 112, rearview camera 114, side cameras 116, and side sensors 118 to process the data to detect erratic actions 134 that could signify impairment. While the vehicle is in motion, the application continues monitoring the driver-facing camera 120 and the eye-detection sensor 122 to continue monitoring eye movement and gestures that may signify impairment.

One skilled in the art understands that continued monitoring while the car is in motion is necessary to detect impairment due to exhaustion, and that belated drug or alcohol absorption in the bloodstream may lead to impairment after some time.

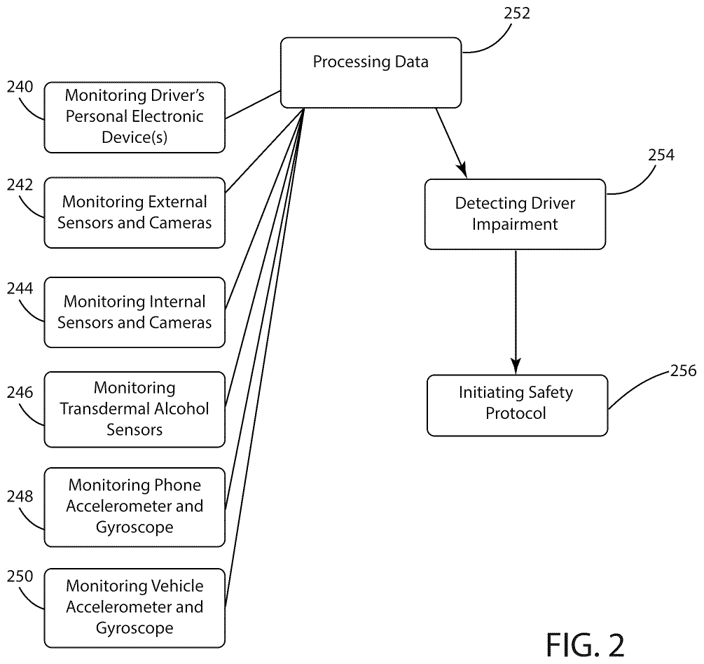

FIG. 2 is a diagram of a method 200 of operating the system of FIG. 1. The program stored in the central-processing unit 138 (FIG. 1) monitors frequencies such as those emitted from Bluetooth Low Energy (BLE) in a driver's personal electronics in the vicinity 240 to gather data. The method continues by processing the data 252 to identify the driver, and by monitoring external sensors and cameras 242. The method continues by processing data 252 to detect unusual gait or movement that may signify impairment 254, which may initiate a safety protocol 256. As a driver enters the vehicle the method continues by monitoring internal sensors and cameras 244 such as that of a driver-facing camera and eye-movement sensors, processing the data 252 to detect driver impairment 254, which may initiate a safety protocol 256.

In some embodiments, the method continues by monitoring transdermal alcohol sensors 246 embedded in the steering wheel. Once that data is processed 252 and impairment is detected 254, the system may initiate a safety protocol 256. As the driver is driving, the method continues monitoring accelerometer and gyroscope data from the driver's personal electronic device 248, wherein by processing the data 252 and detecting driver impairment 254, the method initiates a safety protocol. As the driver continues driving, the method continues monitoring accelerometer and gyroscope data in the vehicle 250, wherein by processing the data 252 and detecting driver impairment 254, the method initiates a safety protocol 256.

1. A system for detecting driver impairment comprising:
a central-processing unit storing an application;
the application configured to receive data from vehicle on-board cameras and sensors; wherein
the data is analyzed to measure the driver's movement and behavior to detect driver impairment and to initiate a safety protocol when impairment is detected.

2. The system of claim 1 further comprising:
the application configured to engage with and receive data from at least one of a vehicle owner's personal electronic devices; wherein
the data received is processed to identify the driver.

3. The system of claim 2 further comprising:
upon identifying the driver, the application is configured to receive data from the vehicle's forward-facing camera, rearview camera, side cameras, and side sensors; wherein
the data is processed to evaluate movement and gait of the driver as they approach the vehicle, to detect impairment.

4. The system of claim 3 further comprising:
the application configured to receive data from the vehicle's driver-facing camera, and eye detection sensors; wherein
the received data is analyzed to measure the driver's eye movement and gestures while the driver is in the vehicle, to detect driver impairment.

5. The system of claim 1 further comprising:
transdermal alcohol sensors embedded in a steering wheel; wherein
data received in the central processing unit, from the transdermal alcohol sensors, is analyzed in the application, to measure the driver's perspiration alcohol content to detect driver impairment.

6. The system of claim 2 further comprising:
the application configured to engage with and receive data from the at least one of a vehicle owner's personal electronic devices accelerometer and gyroscope; wherein
data received in the central processing unit, from the accelerometer and gyroscope, are analyzed in the application to measure the driver's driving activity to detect driver impairment.

7. The system of claim 1 further comprising:
the application configured to receive data from vehicle on-board accelerometer and gyroscope; wherein
data received in the central processing unit, from the accelerometer and gyroscope are analyzed in the application, to measure the driver's driving activity to detect driver impairment.

8. A method of using the system of claim 1, the method comprising:
monitoring and receiving data, in the central processing unit, from vehicle internal sensors; and
processing received data in the application; and
detecting driver impairment; and
initiating a safety protocol when impairment is detected.

9. The method of claim 8 wherein:
at least one of the vehicle internal sensors comprises transdermal alcohol sensors embedded in a vehicle's steering wheel.

10. A method of using the system of claim 2, the method comprising:
monitoring at least one of a driver's personal electronic devices; and
receiving monitored data in the central processing unit; and
processing said data in the application, to identify the driver.

11. The method of claim 9 further comprising:
receiving in the central processing unit, and monitoring, in the application, data from vehicle external sensors and cameras; and
processing received data; and
detecting gait and movement that may signify impairment; and
initiating a safety protocol upon detecting impairment.
